(19) United States
(12) Patent Application Publication
(10) Pub. No.: US 2004/0012696 A1
(43) Pub. Date: Jan. 22, 2004

(54) Method for correcting image signal and image signal processor

(76) Inventors: Masato Teratani, Gifu-ken (JP); Kazuhiro Kazui, Gifu-ken (JP)

Correspondence Address: FISH & RICHARDSON PC, 225 FRANKLIN ST, BOSTON, MA, 02110, US

(21) Appl. No.: 10/190,241

(22) Filed: Jul. 3, 2002

(30) Foreign Application Priority Data
Jul. 6, 2001 (JP) 2001-205664

(51) Int. Cl. H04N 9/64

(52) U.S. Cl. 348/246; 348/251

(57) ABSTRACT

A method for correcting a deficient image signal without lowering the resolution of a display page. The method includes generating an image signal of a subject pixel and image signals of peripheral pixels arranged about the subject pixel. A maximum level and a minimum level of the image signals of the peripheral pixels are detected. The method generates a first reference value by adding a first offset value to the maximum level and a second reference value by subtracting a second offset value from the minimum level. The method further includes generating a correction signal using at least one of the image signals of the peripheral pixels, and replacing the deficient image signal with the correction signal when the level of the image signal of the subject pixel is greater than the first reference value or less than the second reference value.

### BACKGROUND OF THE INVENTION

The present invention relates to a method and processor for detecting and correcting a deficient image signal.

FIG. 1 is a schematic block diagram illustrating the configuration of a prior art imaging apparatus 100. The imaging apparatus 100 includes a solid-state imaging device 1, a drive circuit 2, a timing control circuit 3, an analog signal processing circuit 4, an A/D conversion circuit 5, and a digital signal processing circuit 6.

The solid-state imaging device 1 includes a matrix of light-receiving pixels (not shown) and shift registers (not shown), which are respectively associated with the light-receiving pixels. The solid-state imaging device 1 generates an information charge in accordance with an imaged object and accumulates the information charge in the light-receiving pixels. The solid-state imaging device 1, which operates in accordance with a vertical transfer clock [symbol] v and a horizontal transfer clock [symbol] h, transfers the accumulated information charge in a predetermined order through the shift registers.

The drive circuit 2 receives a vertical synchronizing signal VD and a horizontal synchronizing signal HD and provides the solid-state imaging device 1 with the vertical transfer clock [symbol] v and the horizontal transfer clock [symbol] h. In response to the vertical clock [symbol] v, the solid-state imaging device 1 transfers the information charge accumulated in the light-receiving pixels in the vertical direction in single line units. In response to the horizontal clock [symbol] h, the solid-state imaging device 1 sequentially transfers the information charge of a single line in the horizontal direction in single pixel units. The solid-state imaging device 1 sequentially converts the information charge, which is transferred in single pixel units, to a voltage having a value corresponding to the charge amount, and generates an image signal Y(t). Then, the solid-state imaging device 1 provides the image signal Y(t) to the analog signal processing circuit 4.

The timing control circuit 3 includes a plurality of counters (not shown), which count a reference clock CK that has a constant cycle. The timing control circuit 3 counts the reference clock CK and generates the vertical synchronizing signal VD and the horizontal synchronizing signal HD, which determine the operation timing of the solid-state imaging device 1. The timing control circuit 3 provides the analog signal processing circuit 4, the A/D conversion circuit 5, and the digital signal processing circuit 6 with a timing signal to synchronize the operation of each of the circuits 3, 4, 5 with the operation timing of the solid-state imaging device 1.

The analog signal processing circuit 4 receives the image signal Y(t) from the solid-state imaging device 1. Then, the analog signal processing circuit performs sampling and gain control on the image signal Y(t) in synchronization with the output operation of the solid-state imaging device 1 to generate an image signal Y′(t). The analog signal processing circuit 4, for example, performs a correlated double sampling (CDS) process on the image signal Y(t). A reset level and a signal level are repeated in the image signal Y (t) The CDS process retrieves the signal level after the reset level is clamped and generates an image signal in which the signal level is continuous. The analog signal processing circuit 4 performs automatic gain control (AGC) on the image signals that has undergone the CDS process. The analog signal processing circuit 4 integrates the image signals in single display page units or single vertical scan periods. Then, the analog signal processing circuit 4 feedback controls the gain so that the integrated data is included in a predetermined range.

The A/D conversion circuit 5 standardizes the image signal, which is provided from the analog signal processing circuit 4, at a timing that is in accordance with the output operation of the solid-state imaging device 1 to generate an image signal Y(n) of the digital signal. The image signal Y(n) is provided to the digital signal processing circuit 6.

The digital signal processing circuit 6 performs a color separation process and a matrix calculation process on the image signal Y(n). In the color separation process, for example, the digital signal processing circuit 6 distributes the image signal Y(n) in accordance with a color array of a color filter, which is attached to a light-receiving surface of the solid-state imaging device 1, to generate multiple pieces of color component information. In the matrix calculation process, the digital signal processing circuit 6 synthesizes each of the distributed color components to generate luminance information. The digital signal processing circuit 6 further subtracts a luminance component from each color component to generate chrominance information. The image signal Y′(n) is stored in a storage medium, such as a semiconductor memory or a magnetic disk, and provided to a drive circuit (not shown), which drives the display device (e.g., LCD panel).

In the solid-state imaging device 1, during the period from when the image signal Y(t) is generated to when the image signal Y(t) is shown as an image on a reproduced display page, noise components mix with the image signal Y(t) due to various factors. Noise components distorts the image of a reproduced display page and significantly reduces the visibility of the image. A deficient pixel may be given as one factor that causes noise. Noise resulting from a deficient pixel always appears at the same position in the reproduced display page. Especially, when an object is imaged during the nighttime, a gain is applied to the image signal Y(t) to amplify the level of the image signal Y(t). In this state, the level of the noise resulting from the deficient pixel is amplified. This may virtually increase the noise that is visually discerned from the reproduced display page. To cope with such noise that appears on reproduced display page, the levels of the image signals Y(t) on the entire display page may be averaged to suppress the noise. However, this would lower the resolution of the display page since the levels of the image signals Y(t) for pixels other than the deficient one are also averaged.

### SUMMARY OF THE INVENTION

It is an object of the present invention to provide a method and processor for detecting and correcting a deficient image signal without lowering the resolution of a display page.

To achieve the above object, the present invention provides a method for correcting a deficient image signal included in image signals provided from a solid-state imaging device having a matrix of multiple light-receiving pixels. The multiple light-receiving pixels include a subject pixel and a plurality of peripheral pixels arranged about the subject pixel. The method includes preparing an image signal of the subject pixel and image signals of the peripheral pixels, detecting a maximum level and a minimum level of the image signals of the peripheral pixels, generating a first reference value by adding a first offset value to the maximum level, generating a second reference value by subtracting a second offset value from the minimum level, comparing the level of the image signal of the subject pixel with the first and second reference values, determining that the image signal of the subject pixel is a deficient image signal when the level of the image signal of the subject pixel is greater than the first reference value or when the level of the image signal of the subject pixel is less than the second reference value, generating a correction signal using at least one of the image signals of the peripheral pixels, and replacing the deficient image signal with the correction signal.

A further perspective of the present invention is a method for correcting a deficient image signal included in image signals provided from a solid-state imaging device having a matrix of multiple light-receiving pixels. The multiple light-receiving pixels include a subject pixel and a plurality of peripheral pixels arranged about the subject pixel. The method includes generating an image signal of the subject pixel and image signals of the peripheral pixels, generating a first range using the image signals of the peripheral pixels, generating a second range by adding a predetermined offset range to the first range, determining whether the level of the image signal of the subject pixel is included in the second range, generating a correction signal using at least one of the image signals of the peripheral pixels, and replacing the image signal of the subject pixel with the correction signal when the level of the image signal of the subject pixel is determined as being out of the second range.

A further perspective of the present invention is an image signal processor for correcting a deficient image signal included in image signals provided from a solid-state imaging device having a matrix of multiple light-receiving pixels. The multiple light-receiving pixels include a subject pixel and a plurality of peripheral pixels arranged about the subject pixel. The processor includes a memory circuit connected to the solid-state imaging device for storing image signals of predetermined successive lines and for storing an image signal of the subject pixel and image signals of the peripheral pixels. A register stores first and second offset values. A reference value setting circuit is connected to the memory circuit and the register to receive the image signals of the peripheral pixels and detect a maximum level and a minimum level of the image signals of the peripheral pixels. The reference value setting circuit generates a first reference value by adding the first offset value to the maximum level and generates a second reference value by subtracting the second offset value from the minimum level. A detection circuit is connected to the reference value setting circuit to compare the image signal of the subject pixel with the first and second reference values. The detection circuit generates a deficiency detection signal when the level of the image signal of the subject pixel is greater than the first reference value or when the level of the image signal of the subject pixel is less than the second reference value. A correction circuit is connected to the memory circuit and the detection circuit to generate a correction signal using at least one of one image signals of the peripheral pixels. The correction circuit replaces the image signal of the subject pixel with the correction signal in response to the deficiency detection signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram illustrating the configuration of a prior art imaging apparatus;

FIG. 2 is a flowchart illustrating a process for correcting an image signal according to a preferred embodiment of the present invention;

FIG. 3 is a plan view showing the positional relationship between a subject pixel and peripheral pixels;

FIGS. 4A to 4C are plan views showing the positional relationship between subject pixels and peripheral pixels when color imaging is performed;

FIG. 5 is a schematic block diagram of an image signal processor according to a preferred embodiment of the present invention;

FIG. 6 is a schematic block diagram of a memory circuit incorporated in the image signal processor of FIG. 5;

FIG. 7 is a schematic block diagram of a reference value setting circuit incorporated in the image signal processor of FIG. 5;

FIG. 8 is a schematic block diagram of a further example of the reference value setting circuit of FIG. 7;

FIG. 9 is a schematic block diagram of a detection circuit incorporated in the image signal processor of FIG. 5; and

FIG. 10 is a schematic block diagram showing a correction circuit incorporated in the image signal processor of FIG. 5.

### DETAILED DESCRIPTION OF THE PREFERRED EMBODIMENTS

In the drawings, like numerals are used for like elements throughout.

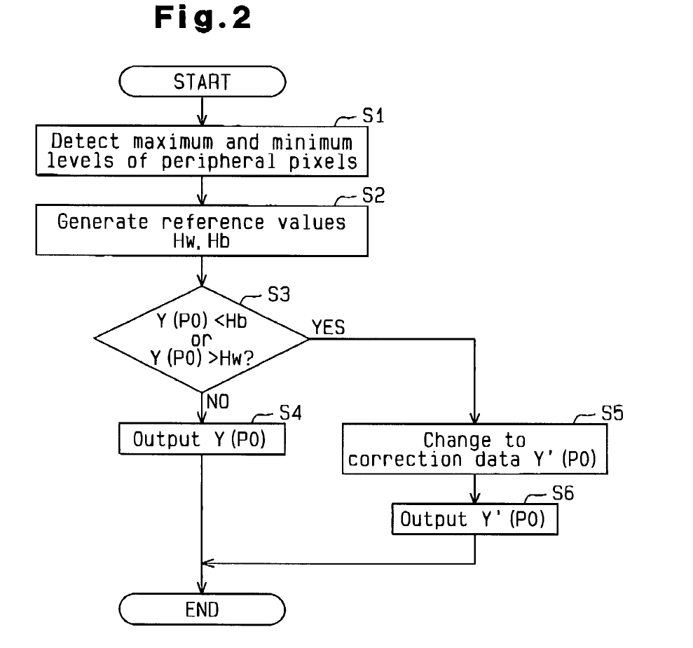

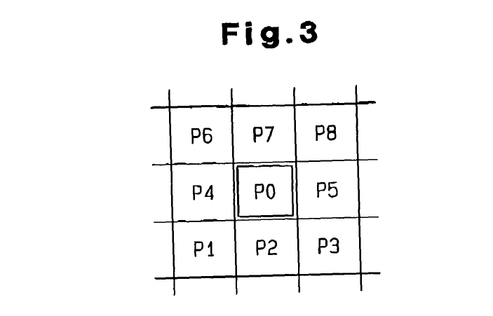

FIG. 2 is a flowchart illustrating a process for correcting an image signal according to a preferred embodiment of the present invention. The process illustrated by the flowchart determines whether an image signal corresponding to a subject pixel is a deficient image signal and, if the image signal is deficient, corrects the deficient image signal. An example shown in FIG. 3, in which peripheral pixels P1-P8 are arranged about a subject pixel P0, is used in the flowchart of FIG. 2.

Referring to FIG. 2, in step S1, a maximum level Hmax and a minimum level Hmin of image signals Y(P0) to Y(P8), which are associated with peripheral pixels P1-P8, are detected. In step S2, a predetermined offset value OS is added to the detected maximum level Hmax to set a first reference value Hw. Simultaneously, the offset value OS is subtracted from the minimum level Hmin to set a second reference value Hb. The first and second reference values set in step S2, which vary in accordance with the maximum and minimum levels of the peripheral pixels, are constantly held at an optimal value.

The offset value OS is a default value preset so that the first and second reference values Hw, Hb are values that are appropriate for detecting a deficient image signal. In accordance with the adjustment of level correction performed during signal processing, the offset value OS may be changed when necessary. For example, a coefficient corresponding to a gain value used for level adjustment may be added to the set default value. This associates the detection level of the deficient image signal with changes in the luminance and suppresses detection differences caused by different imaging conditions.

The offset value OS may include a first offset value and a second offset value. In this case, for example, the first reference value is generated by adding the first offset value to the maximum level and the second reference value is generated by subtracting the second offset value from the minimum level. The first offset value and the second offset value may be the same. Alternatively, the first offset value and the second offset value values may differ from each other.

In step S3, the image signal Y(P0) of the subject pixel P0 is compared to the first and second reference values Hw, Hb. When the image signal Y(P0) is included in a range defined by the first and second reference values Hw, Hb (Hb≦Y(0)≦Hw; second range), it is determined that the image signal Y(P0) is normal. In such a case, the process proceeds to step S4. When the image signal Y(P0) is greater than the first reference value Hw (Y(P0)>Hw) or when the image signal Y(P0) is less than the second reference value Hb (Y(P0)<Hb), it is determined that the image signal Y(P0) is a deficient signal. In such a case, the process proceeds to step S5. The determination of step S3 is sequentially performed in single pixel units on successively output image signals.

In step S4, the image signal Y(P0), which has been determined as being normal in step S3, is output to undergo the following process. In step S5, the image signal Y(P0), which has been determined as being deficient in step S3, is replaced by a correction signal Y′(P0) to correct the deficient signal. The correction signal Y′(P0) is generated by, for example, averaging two of the image signals Y(P1) to Y(P8). In step S5, deficient pixels are sequentially corrected when a deficient pixel is detected through the determination of step S3. The correction is performed in synchronization with the timing the image signal Y(t) is output from the solid-state imaging device 1. This corrects the image signal that includes noise cased by a deficient pixel, which appears at the same position on a reproduced display page. Further, when the signal level of an image signal is the same as that of a deficient pixel, an image signal causing noise that appears in an irregular manner on a reproduced display page is also corrected.

When a color filter is attached to the solid-state imaging device 1 to perform color imaging, the color component of the subject pixel is not necessarily the same as the color component of the peripheral pixels, which are arranged next to the subject pixel. For example, in a mosaic color filter, in which a plurality of color components are arranged in accordance with the Bayer pattern, adjacent pixels are associated with different color components. In the color filter, color components have different spectral transmission characteristics. Thus, a reference value cannot be generated from peripheral pixels such as those shown in FIG. 3. Thus, during color imaging, among the pixels arranged about the subject pixel, those associated with the same color component as the subject pixel are used to generate the reference value. The correction signal is also generated using the image signals that are associated-with the same color component as the subject pixel.

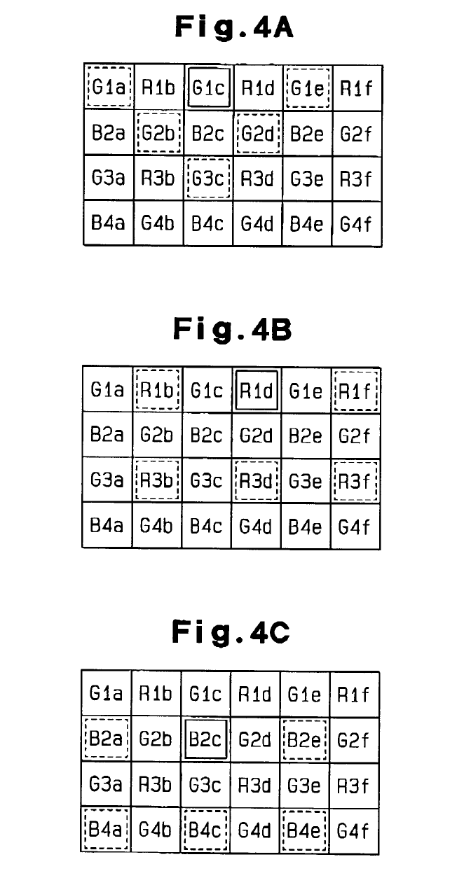

FIGS. 4A to 4C show arrays of the three color components of red (R), green (G), and blue (B) and will be used to describe an example of a process for correcting an image signal during color imaging. FIGS. 4A to 4C illustrate a Bayer pattern employed in, for example, a mosaic color filter of the solid-state imaging device 1. A line memory stores the image signal of four lines including the line of the subject pixel.

For example, referring to FIG. 4A, when the subject pixel is G1c, the maximum level and the minimum level of the image signal in the peripheral pixels associated with color component G is detected. The reference value is generated in accordance with the detected maximum and minimum levels. That is, referring to FIG. 4A, the maximum level Hmax and minimum level in the image signals of the peripheral pixels G1a, G1e, G2b, and G3c are detected. A predetermined offset value OS is added to the maximum level Hmax to generate the first reference value Hw. The predetermined offset value OS is subtracted from the minimum value to generate the second reference value Hb. When the image signal level of the subject pixel G1c is greater than the first reference value Hw or less then the second reference value Hb, it is determined that the image signal of the subject pixel G1c is deficient. Thus, the deficient image signal of the subject pixel G1c is replaced by a correction signal, which is generated by averaging two of the peripheral pixels G1a, G1e, G2b, G3c.

In the same manner, for the image signals of pixels associated with color components other than C, that is, color components R and B, a reference value is generated from peripheral pixels associated with the same color component as the subject pixel. For example, referring to FIG. 4B, when pixel R1d is the subject pixel, the reference value is generated by referring to the maximum and minimum image signal levels of the peripheral pixels R1b, R1f, R3b, R3d, and R3f. Referring to FIG. 4C, when pixel B2c is the subject pixel, the reference value is generated by referring to the maximum and minimum image signal levels of the peripheral pixels B2a, B2e, B4a, B4c, and B4e. The generated reference value is compared with the subject pixel to detect the deficient pixel. Peripheral pixels associated with the same color component are averaged to generate the correction signal in accordance with the detection. The deficient image signal is replaced by the correction signal.

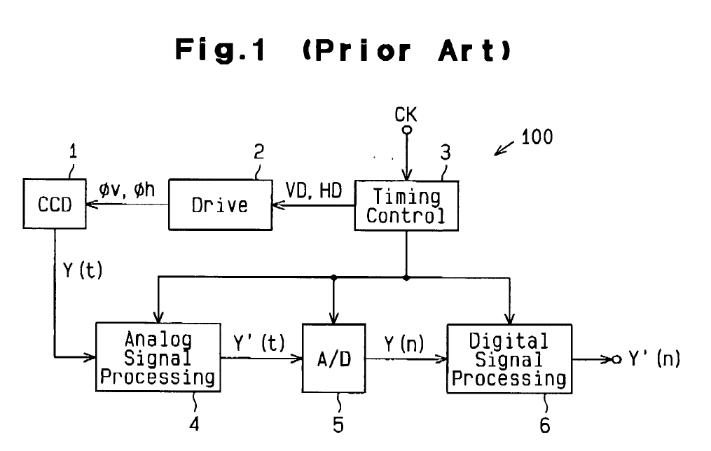

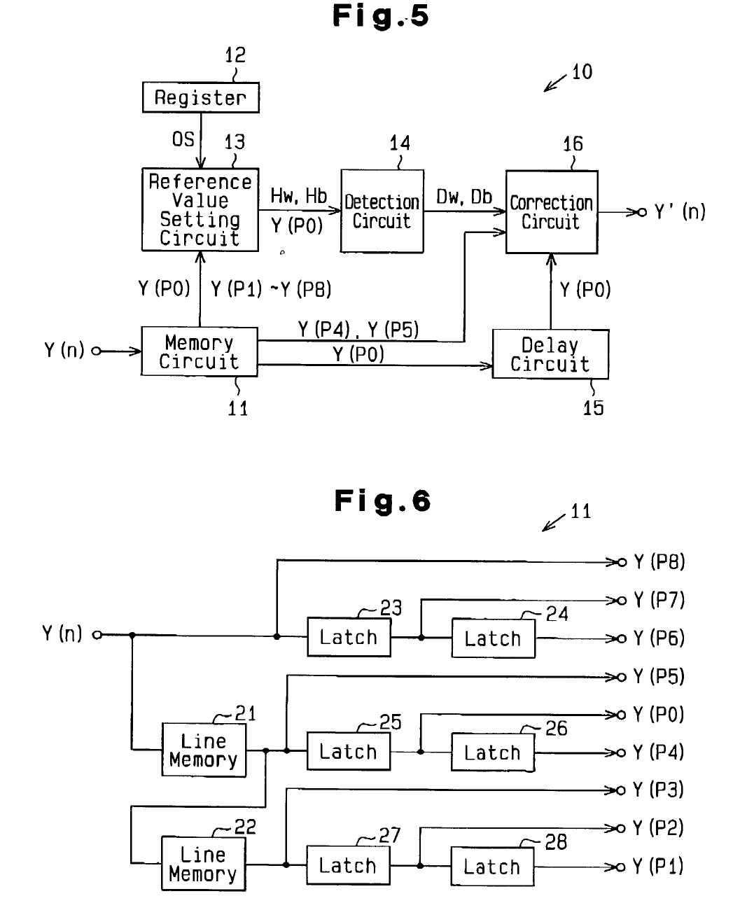

FIG. 5 is a schematic block diagram of an image signal processor 10 that performs the above process for correcting an image signal. The image signal processor 10 includes a memory circuit 11, a register 12, a reference value setting circuit 13, a detection circuit 14, a delay circuit 15, and a correction circuit 16. The image signal processor 10 corrects deficient pixel signals included in image signals Y(n), which have been converted to digital signals (refer to FIG. 1). The operation of the image signal processor 10 will now be discussed referring to FIG. 3 in which the subject pixel is P0 and the peripheral pixels are P1-P8.

A memory circuit 11 includes a plurality of line memories. The memory circuit 11 continuously receives an image signal Y(n) in single line units and provides an image signal Y(P0), which is associated with a subject pixel P0, and image signals Y(P1)-Y(P8) to a reference value setting circuit 13 in a parallel manner. The register 12 holds a predetermined offset value OS and provides the reference value setting circuit 13 with the offset value OS in synchronism with the timing the image signals Y(P0)-Y(P8) are output from the memory circuit 11.

The reference value setting circuit 13 detects the maximum level Hmax and the minimum level Hmin in the image signals Y(P1)-Y(P8) of the peripheral pixels provided from the memory circuit 11. The reference value setting circuit 13 adds the offset value OS, which is provided from the register 12, to the maximum level Hmax to set the first reference value HW and subtracts the offset value OS from the minimum level Hmin to set the second reference value Hb. The first and second reference values Hw, Hb are provided to the detection circuit 14.

The detection circuit 14 sequentially compares the level of the image signal Y(P0) of the subject pixel P0 and the levels of the first and second determination reference values Hw, Hb. The detection circuit 14 generates detection signals Ow, Db, which indicate the detection of a deficient image signal, when the level of the image signal Y(P0) of the subject pixel P0 is greater than the first reference value Hw or less than the second reference value Hb.

The delay circuit 15 retrieves the image signal Y(P0), which is provided from the memory circuit 11, and delays the image signal Y(P0) by the time required for the detection circuit 14 to perform a detection operation on the image signal Y(P0). The delay circuit 15 provides the correction circuit 16 with the delayed image signal Y(P0) in synchronism with the timing the detection circuit 14 performs the detection operation.

When the detection signals Dw, Db, which are provided from the detection circuit 14 goes high, the correction circuit 16 replaces the delayed image signal YP(0), which is provided from the delay circuit 15, with the correction signal Y′(P0). The correction signal Y′(P0) is generated by, for example, dividing the levels of the image signals Y(P4), Y(P5), which correspond to the two pixels P4, P5 arranged next to the left and right sides of the subject pixel P0, by two and adding the divided image signals Y(F4), Y(P5) to each other. The correction circuit 16 sequentially replaces the image signal Y(P0), which is determined as being a deficient image signal by the detection circuit 14, with the correction signal Y′(P0).

The image signal processor 10 will now be discussed with reference to FIGS. 6 to 10.

FIG. 6 is a block diagram showing an example of the memory circuit 11. The memory circuit 11 includes first and second line memories 21, 22 and first to sixth latches 23-28. The first and second line memories 21, 22 are connected to each other in series.

The image signal Y(n) sequentially input in the memory circuit 11 is written to the first line memory 21, and the image signal sequentially read from the first line memory 21 is written to the second line memory 22. In this state, with respect to the sequentially input image signal Y(n), the image signal of the line that is one line before the present line is read from the first line memory 21, and the image signal of the line that is two lines before the present line is read from the second line memory 22.

The first and second latches 23, 24 are sequentially connected in series with respect to the image signal Y(n), which is provided to the memory circuit 11. The first latch 23 holds the image signal Y(n) of the pixel that is one pixel before the present pixel. The second latch 24 holds the image signal Y(n) of the pixel that is two pixels before the present pixel. The image signal Y(P8), which is associated with the peripheral pixel P8 of FIG. 3, is thus output without being latched. The image signals Y(P6), Y(P7) associated with the peripheral pixels P6, P7 are output after being held by the first and second latches 23, 24, respectively.

The third and fourth latches 25, 26 are sequentially connected in series with respect to the image signal Y(n), which is received from the first line memory 21. The third latch 25 holds the image signal Y(n) of the pixel that is one pixel before the present pixel. The fourth latch 26 holds the image signal Y(n) of the pixel that is two pixels before the present pixel. The image signal Y(P5), which is associated with the peripheral pixel P5 of FIG. 3, is thus output without being latched. The image signals Y(P0), Y(P4) associated with the peripheral pixels P0, P4 are output after being held by the third and fourth latches 25, 26, respectively.

The fifth and sixth latches 27, 28 are sequentially connected in series with respect to the image signal Y(n), which is received from the second line memory 22. The fifth latch 27 holds the image signal Y(n) of the pixel that is one pixel before the present pixel. The sixth latch 28 holds the image signal Y(n) of the pixel that is two pixels before the present pixel. The image signal Y(P3), which is associated with the peripheral pixel P5 of FIG. 3, is thus output without being latched. The image signals Y(P2), Y(P1) associated with the peripheral pixels P2, P1 are output after being held by the fifth and sixth latches 27, 28, respectively.

While sequentially retrieving the image signal Y(n), the memory circuit 11 provides the reference value setting circuit 13 with the image signal Y(P0), which is associated with the subject pixel P0, and the image signals Y(P1)-Y(P8), which are respectively associated with the peripheral pixels PL-PB arranged about the subject pixel P0, in a parallel manner.

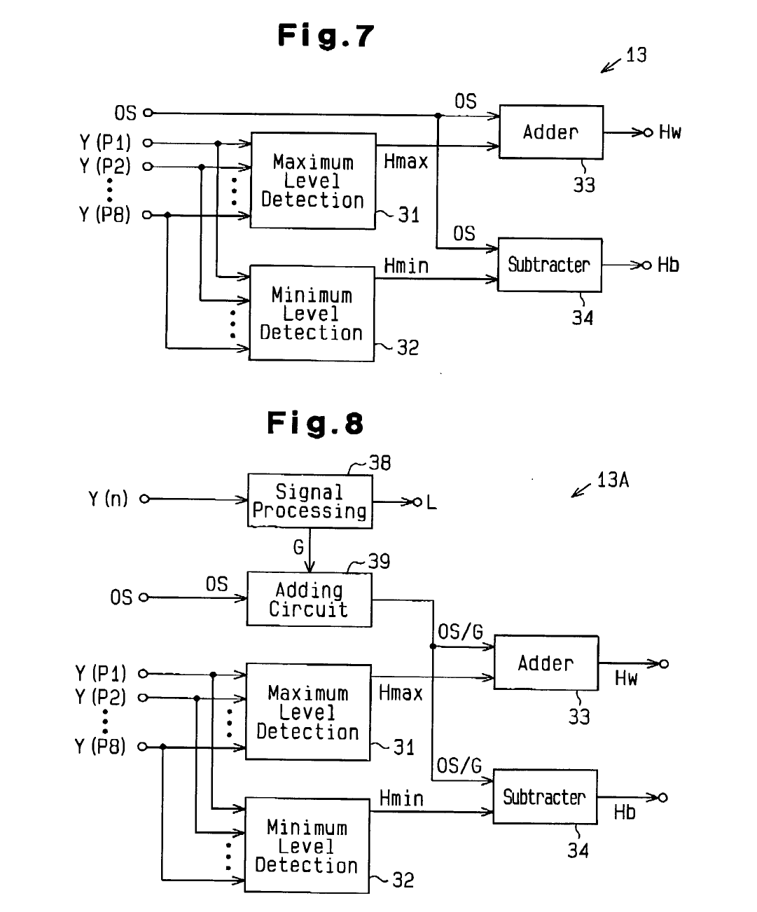

FIG. 7 is a schematic block diagram showing an example of the reference value setting circuit 13. As shown in FIG. 7, the reference value setting circuit 13 includes a maximum level detection circuit 31, a minimum level detection circuit 32, an adder 33, and a subtracter 34.

Among the image signals Y(P0)-Y(28), which are provided in parallel, the maximum level detection circuit 31 receives the image signals Y(P1)-Y(P8), detects the maximum level Hmax of the image signals Y(P1)-Y(P8), and provides the adder 33 with the maximum level Hmax. The minimum level detection circuit 32 receives the image signal Y(P1)-Y(P8), detects the minimum level Hmin of the image signals Y(P1)-Y(P8), and provides the subtracter 34 with the minimum level Hmin.

The adder 33 receives the offset value OS from the register 12 and the maximum level Hmax from the maximum level detection circuit 31. The adder 33 adds the offset value OS to the maximum value Hmax to set the first reference value Hw. The subtracter 34 receives the offset value OS from the register 12 and the minimum level Hmin from the minimum level detection circuit 32. The subtracter 34 subtracts the offset value OS from the minimum level Hmin to set the second reference value Hb.

The reference value setting circuit 13 may change the offset value OS, which is provided from the register 12, in accordance with the gain value that is set when the image signals Y(n) are being processed. A reference value setting circuit 13A, which is shown in FIG. 8, further includes a signal processing circuit 38 and a coefficient adding circuit 39.

The signal processing circuit 38 receives the image signals Y(n), which are output from an imaging device, and integrates the image signals Y(n) in single display units or single vertical scan periods. In accordance with the integral data, the signal processing circuit 38 generates control data CON, which is used for level correction of the image signal Y(n) and for white balance correction. In accordance with the control data CON, the signal processing circuit 38 calculates the gain value G so that the integral data of the image signal Y(n) is included in a predetermined range. The signal processing circuit 38 then provides the calculated gain value G to the coefficient adding circuit 39.

The coefficient adding circuit 39 receives the gain value G and the offset value OS from the register 12. Further, the coefficient adding circuit 39 adds a coefficient, which is in correspondence with the gain value G, to the offset value OS. For example, when the coefficient is an inverse 1/G of the gain value G, the coefficient adding circuit 39 generates a coefficient-added offset value OS/G. In this case, the offset value OS/G is added to the maximum level Hmax to generate the first reference value Hw, and the coefficient-added offset value OS/G is subtracted from the minimum level Hb to generate the second reference value Hb. By changing the offset value OS in accordance with the adjustment of the gain value G, the detection level of the deficient image signal is associated with changes in the imaging conditions.

The coefficient-added offset value OS/G may include a first coefficient-added offset value and a second coefficient-added offset value. In this case, for example, the first reference value is generated by adding the coefficient-added first offset value to the maximum level and the second reference value is generated by subtracting the second coefficient-added offset value from the minimum level. The first coefficient-added offset value and the second coefficient-added offset value may be the same. Alternatively, the first coefficient-added offset value and the second coefficient-added offset value values may differ from each other.

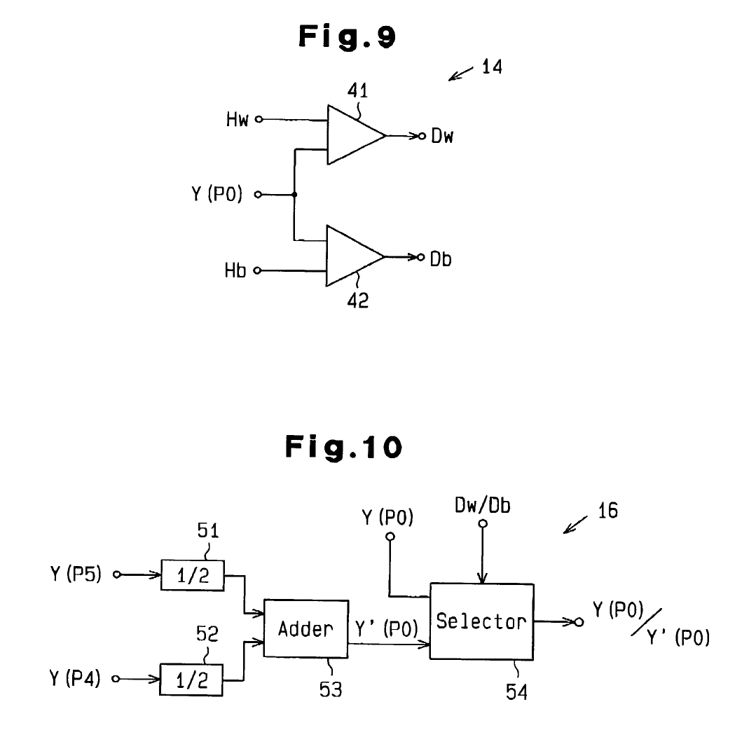

FIG. 9 is a schematic block diagram illustrating an example of the detection circuit 14. The detection circuit 14 includes a first comparator 41 and a second comparator 42.

The first comparator 41 compares the first reference value Hw, which is provided from the adder 33, will the first reference value Hw. Further, the first comparator 41 generates a detection signal Dw, which indicates the detection of the deficient image signal, when the image signal Y(P0) is greater than the first reference value Hw. The second comparator 42 compares the second reference value Hb, which is provided from the subtracter 34, with the second reference value Hb. Further, the second comparator 42 generates a detection signal Db, which indicates the detection of the deficient image signal, when the image signal Y(P0) is less than the second reference value Hb.

FIG. 10 is a schematic block diagram showing an example of the correction circuit 16. The correction circuit includes first and second dividers 51, 52, an adder 53, and a selector 54.

The first and second dividers 51, 52 receive, for example, image signals Y(d4), Y(d5), which are respectively associated with the peripheral pixels P4, P5, and divide the image signals Y(P4), Y(P5) by two. The adder 53 adds the divisions of the first and second dividers 51, 52 to generate the correction signal Y′(P0).

In accordance with the detection signals Dw, Db, which are provided from the detection circuit 14, the selector 54 selectively outputs one of the image signal Y(P0) and the correction signal Y′(P0) The selector 54 selects the correction signal Y′(P0) when a deficient image signal is detected and one of the detection signals Dw, Ob goes high, It both of the detection signals Dw, Db do not go high, the selector 54 selects the image signal Y(P0). This replaces the image signal Y(P0) with the correction signal Y′(P0) and outputs the correction signal Y′(P0) in accordance with the detection of a deficient image signal.

In the preferred embodiment, the image signal Y(P0) is sequentially replaced by the correction signal Y′(P0) when one of the detection signals De, Db goes high. This corrects the image signal Y(P0) when it includes noise that results from a deficient pixel appearing at the same position on a reproduced display page. The image signal Y(P0) is also corrected when having the same level as a deficient pixel and including noise that appears on a reproduced display page in an irregular manner.

The image signal processor 10 of the preferred embodiment adds the offset value OS to the maximum level Hmax of the peripheral pixels arranged about the subject pixel or subtracts the offset value OS from the minimum level Hmin to generate the reference values Hw, Hb. Further, the image signal processor 10 compares the reference values Hw, Hb with the image signal associated with the subject pixel to detect a deficient image signal. In accordance with the detection signals Dw, Db, which go high in response to a detection of a deficient image signal, the image signal processor 10 replaces the deficient image signal with the correction signal to sequentially correct the image signal.

When performing color imaging, the image signal processor 10 sets a reference value in accordance with multiple pixels associated with a color component that is the same as that of the subject pixel. The image signal processor 10 compares the reference value with the image signal associated with the subject pixel and detects a deficient image signal. When a deficient image signal is detected, the image signal processor 10 generates a correction signal using an image signal of at least one of the multiple pixels associated with the same color component as the subject pixel and replaces the deficient image signal with the correction signal.

The preferred embodiment has the advantages described below.

(1) A deficient image signal is solely corrected without affecting image signals that are not deficient. This maintains satisfactory resolution and eliminates noise caused by a deficient image signal.

(2) When a deficient image signal is detected, the deficient image signal is sequentially replaced by a correction signal. This corrects an image signal that includes noise, which is caused by a deficient pixel and which appears at the same position on a reproduced display page. Further, an image signal Y(P0) including noise that appears on a reproduced display page in an irregular manner is also corrected.

It should be apparent to those skilled in the art that the present invention may be embodied in many other specific forms without departing from the spirit or scope of the invention. Particularly, it should be understood that the present invention may be embodied in the following forms.

The correction signal may be generated using one of the pixels located around the subject pixel. The correction signal may also be generated using two or more of the pixels located around the subject pixel. For example, when the correction signal is generated using four pixels, the image signal level of each pixel is divided by four, and the divided image signal levels of the four pixels may be added to generate the correction signal. Alternatively, the signal level of two of the pixels may be divided by eight and ⅜ of the image signal levels of two other pixels may be obtained to generate the correction signal by adding the resulting image signal levels of the four pixels. The image signal level of each pixel may be processed in any manner.

The present examples and embodiments are to be considered as illustrative and not restrictive, and the invention is not to be limited to the details given herein, but may be modified within the scope and equivalence of the appended claims.

What is claimed is:

1. A method for correcting a deficient image signal included in image signals provided from a solid-state imaging device having a matrix of multiple light-receiving pixels, wherein the multiple light-receiving pixels include a subject pixel and a plurality of peripheral pixels arranged about the subject pixel, the method comprising the steps of:
preparing an image signal of the subject pixel and image signals of the peripheral pixels;
detecting a maximum level and a minimum level of the image signals of the peripheral pixels;
generating a first reference value by adding a first offset value to the maximum level;
generating a second reference value by subtracting a second offset value from the minimum level;
comparing the level of the image signal of the subject pixel with the first and second reference values;
determining that the image signal of the subject pixel is a deficient image signal when the level of the image signal of the subject pixel is greater than the first reference value or when the level of the image signal of the subject pixel is less than the second reference value;
generating a correction signal using at least one of the image signals of the peripheral pixels; and
replacing the deficient image signal with the correction signal.

2. The method according to claim 1, further comprising the steps of:
integrating the image signals provided from the solid-state imaging device to generate an integrated image signal and calculating a gain value so that the integrated image signal is included in a predetermined range; and
generating first and second coefficient-added offset values by adding a coefficient, which corresponds to the first and second gain values, to the offset value;
wherein the step for generating the first reference value includes adding the first coefficient-added offset value to the maximum level to generate the first reference value; and
wherein the step for generating the second reference value includes subtracting the second coefficient-added offset value from the minimum level to generate the second reference value.

3. The method according to claim 1, wherein the step for generating the correction signal includes;
dividing each of the image signals of the peripheral pixels by a predetermined number to generate divided image signals of the peripheral pixels; and
adding the divided image signals to generate the correction signal.

4. The method according to claim 1, wherein the solid-state imaging device includes a color filter having a plurality of color components arranged in a predetermined order, and the solid-state imaging device outputs an image signal associated with each color component in single pixel units, the method further comprising the step of:
generating the first and second reference value for each color component; and
wherein the step for generating the correction signal includes generating the correction signal using at least one of the image signals of the peripheral pixels associated with a color component that is the same as the color component of the subject pixel.

5. A method for correcting a deficient image signal included in image signals provided from a solid-state imaging device having a matrix of multiple light-receiving pixels, wherein the multiple light-receiving pixels include a subject pixel and a plurality of peripheral pixels arranged about the subject pixel, the method comprising the steps of:
preparing an image signal of the subject pixel and image signals of the peripheral pixels;
generating a first range using the image signals of the peripheral pixels;
generating a second range by adding a predetermined offset range to the first range;
determining whether the level of the image signal of the subject pixel is included in the second range;
generating a correction signal using at least one of the image signals of the peripheral pixels; and
replacing the image signal of the subject pixel with the correction signal when the level of the image signal of the subject pixel is determined as being out of the second range.

6. An image signal processor for correcting a deficient image signal included in image signals provided from a solid-state imaging device having a matrix of multiple light-receiving pixels, wherein the multiple light-receiving pixels include a subject pixel and a plurality of peripheral pixels arranged about the subject pixel, the processor comprising:
a memory circuit connected to the solid-state imaging device for storing image signals of predetermined successive lines and for storing an image signal of the subject pixel and image signals of the peripheral pixels;
a register for storing first and second offset values;
a reference value setting circuit connected to the memory circuit and the register for receiving the image signals of the peripheral pixels and detecting a maximum level and a minimum level of the image signals of the peripheral pixels, wherein the reference value setting circuit generates a first reference value by adding the first offset value to the maximum level and generates a second reference value by subtracting the second offset value from the minimum level;
a detection circuit connected to the reference value setting circuit for comparing the image signal of the subject pixel with the first and second reference values, wherein the detection circuit generates a deficiency detection signal when the level of the image signal of the subject pixel is greater than the first reference value or when the level of the image signal of the subject pixel is less than the second reference value; and
a correction circuit connected to the memory circuit and the detection circuit for generating a correction signal using at least one of the image signals of the peripheral pixels, wherein the correction circuit replaces the image signal of the subject pixel with the correction signal in response to the deficiency detection signal.

7. The image signal processor according to claim 6, further comprising:
a delay circuit connected between the memory circuit and the correction circuit for receiving the image signal of the subject pixel, delaying the image signal of the subject pixel by a predetermined time, and providing the correction circuit with the delayed image signal of the subject pixel;
wherein the correction circuit replaces the delayed image signal of the subject pixel with the correction signal in response to the deficiency detection signal.

8. The image signal processor according Lo claim 6, wherein the reference value setting circuit includes:
a signal processing circuit connected to the solid-state imaging device for integrating the image signals to generate an integrated image signal and calculating a gain value so that the integrated image signal is included in a predetermined range; and
a coefficient-adding circuit connected to the signal processing circuit and the register for adding a coefficient, which corresponds to the gain value, to the first and second offset values to generate first and second coefficient-added offset values;
wherein the reference value setting circuit adds the first coefficient-added offset value to the maximum level to generate the first reference value and subtracts the second coefficient-added offset value from the minimum level to generate the second reference value.

9. The image signal processor according to claim 6, wherein the correction circuit includes:
a divider for dividing each of the image signals of the peripheral pixels with a predetermined number and generating divided image signals of the peripheral pixels; and
an adder for adding the divided image signals to generate the correction signal.

10. The image signal processor according to claim 6, wherein the solid-state imaging device includes a color filter having a plurality of color components arranged in a predetermined order, and the solid-state imaging device outputs an image signal associated with each color component in single pixel units;
wherein the reference value setting circuit generates the first and second reference value for each color component; and
wherein the correction circuit generates the correction signal using at least one of the image signals of the peripheral pixels associated with a color component that is the same as the color component of the subject pixel.
